(19) United States
(12) Patent Application Publication
(10) Pub. No.: US 2025/0126022 A1
(43) Pub. Date: Apr. 17, 2025

(54) DYNAMIC TENANT NETWORK TOPOLOGY DISCOVERY IN A MULTI-TENANT DATA CENTER

(71) Applicant: VMware LLC, Palo Alto, CA (US)

(72) Inventors: Chandan GHOSH, Bangalore (IN); Anantha Mohan Raj MURUGANDI DURAIRAJ, Bangalore (IN)

(21) Appl. No.: 18/607,161

(22) Filed: Mar. 15, 2024

(30) Foreign Application Priority Data
Oct. 17, 2023 (IN) 202341070627

(51) Int. Cl. H04L 41/12; H04L 41/0604; H04L 41/082

(52) U.S. Cl. CPC H04L 41/12; H04L 41/0627; H04L 41/082

(57) ABSTRACT

An example method of managing tenant networks in a data center includes: obtaining, by tenant network topology discovery software executing in the data center, inventory data for a tenant network deployed in the data center from a network manager, the tenant network comprising a software-defined network managed by the network manager; generating, by the tenant network topology discovery software, a tenant network model based on the inventory data, the tenant network model including objects representing components of the tenant network and relationships between the components; storing, by the tenant network topology discovery software, the tenant network model in a database; and updating, by the tenant network topology discovery software, the tenant network model in response to monitoring the tenant network.

### CROSS-REFERENCE

This application is based upon and claims the benefit of priority from Indian Patent Application No. 202341070627, filed on Oct. 17, 2023, the entire contents of which are incorporated herein by reference.

### BACKGROUND

In a software-defined data center (SDDC), virtual infrastructure, which includes virtual compute, storage, and networking resources, is provisioned from hardware infrastructure that includes a plurality of host computers, storage devices, and networking devices. The provisioning of the virtualized infrastructure is carried out by virtualization software, which includes hypervisors installed in the host computers (“virtualized hosts”) and management software for managing the virtualized hosts. The management software can include a network manager for managing a software defined network (SDN) in the SDDC. An SDDC can support multiple tenants. Tenants can be different customers, different organizations, different business units, etc., which share the SDDC. Each tenant can deploy its own SDN in the SDDC (“tenant network”).

A large number of tenants can lead to a large number of tenant networks. Detecting and resolving problems in the tenant networks can be a challenge for an administrator of the SDDC. For example, logs are a primary source of debugging problems in the SDDC. Logs can be generated by virtual infrastructure components. Some logs are not tenant-aware, making it difficult for an administrator of the SDDC to diagnose and address problems with tenant networks.

### SUMMARY

In an embodiment, a method of managing tenant networks in a data center includes: obtaining, by tenant network topology discovery software executing in the data center, inventory data for a tenant network deployed in the data center from a network manager, the tenant network comprise a software-defined network managed by the network manager; generating, by the tenant network topology discovery software, a tenant network model based on the inventory data, the tenant network model including objects representing components of the tenant network and relationships between the components; storing, by the tenant network topology discovery software, the tenant network model in a database; and updating, by the tenant network topology discovery software, the tenant network model in response to monitoring the tenant network.

Further embodiments include a non-transitory computer-readable storage medium comprising instructions that cause a computer system to carry out the above method, as well as a computer system configured to carry out the above method.

### BRIEF DESCRIPTION OF THE DRAWINGS

FIG. 1 is a block diagram of a virtualized computing system in which embodiments described herein may be implemented.

FIG. 2 is a flow diagram depicting a method of generating tenant network models according to embodiments.

FIG. 3 is a block diagram depicting tenant network topology discovery software according to embodiments.

FIG. 4 is a flow diagram depicting a method of managing a tenant network topology according to embodiments.

FIG. 5 is a flow diagram depicting a method of managing alarms and events generated by a tenant network according to embodiments.

FIG. 6 is a block diagram depicting a tenant network model according to embodiments.

FIG. 7 is a block diagram depicting a tenant network model relationship according to embodiments.

FIG. 8 is a block diagram depicting a tenant network model according to embodiments.

### DETAILED DESCRIPTION

Dynamic tenant network topology discovery in a multi-tenant data center is described. A multi-tenant data center can support many tenants (e.g., individual users, companies, business units, and the like). Each tenant is an entity having access to separate virtualized infrastructure in the data center. Notably, each tenant can include virtualized infrastructure with its own network topology. With many tenants, and each tenant potentially having a different network topology, detecting and resolving problems in tenant networks for an administrator of the data center can be a major challenge. In embodiments, a dynamic tenant network topology discovery engine is described. The discovery engine obtains information about all elements of each tenant network and its operational state. The collected information is stored in a database and periodically updated by detecting changes to the tenant network topologies. Each tenant network topology has a hierarchical representation where an element is represented as an object with attributes that maintain state information. A network topology can be used to perform analysis of failures, resource planning, and orchestration in the data center. A tenant network monitor is configured to capture the information for the tenant networks. These and other aspects of the embodiments are described below with respect to the drawings.

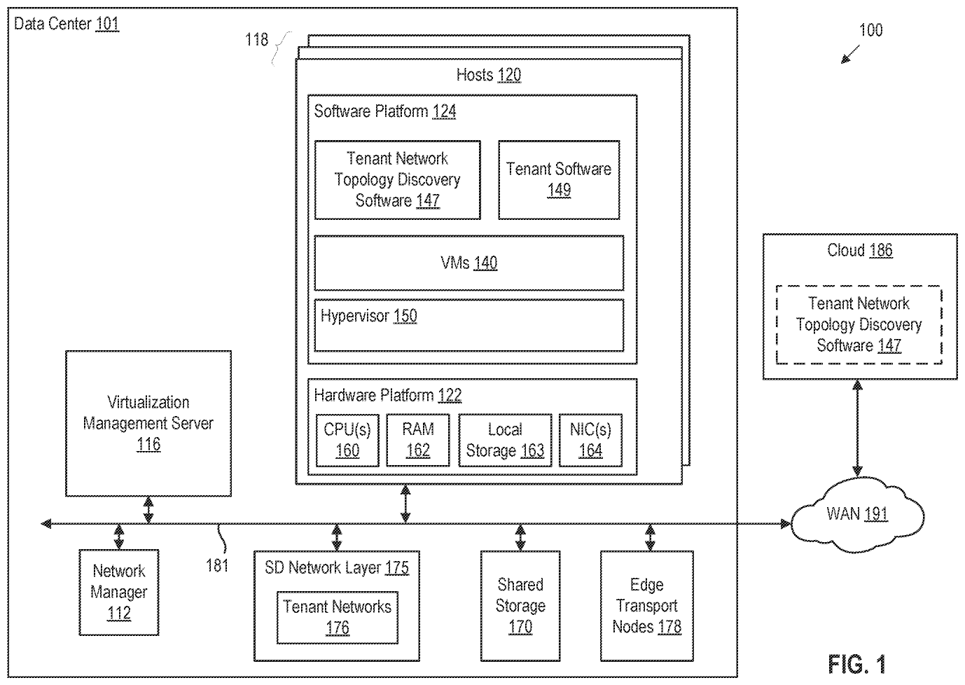

FIG. 1 is a block diagram of a virtualized computing system 100 in which embodiments described herein may be implemented. Virtualized computing system includes a data center 101. In embodiments, the data center 100 can be in communication with a cloud 186 through a wide area network (WAN) 191 (e.g., the public Internet).

Data center 101 includes hosts 120. Hosts 120 may be constructed on hardware platforms such as an x86 architecture platforms. One or more groups of hosts 120 can be managed as clusters 118. As shown, a hardware platform 122 of each host 120 includes conventional components of a computing device, such as one or more central processing units (CPUs) 160, system memory (e.g., random access memory (RAM) 162), one or more network interface controllers (NICs) 164, and optionally local storage 163. CPUs 160 are configured to execute instructions, for example, executable instructions that perform one or more operations described herein, which may be stored in RAM 162. NICs 164 enable host 120 to communicate with other devices through a physical network 181. Physical network 181 enables communication between hosts 120 and between other components and hosts 120 (other components discussed further herein).

In the embodiment illustrated in FIG. 1, hosts 120 access shared storage 170 by using NICs 164 to connect to network 181. In another embodiment, each host 120 contains a host bus adapter (HBA) through which input/output operations (IOs) are sent to shared storage 170 over a separate network (e.g., a fibre channel (FC) network). Shared storage 170 include one or more storage arrays, such as a storage area network (SAN), network attached storage (NAS), or the like. Shared storage 170 may comprise magnetic disks, solid-state disks, flash memory, and the like as well as combinations thereof. In some embodiments, hosts 120 include local storage 163 (e.g., hard disk drives, solid-state drives, etc.). Local storage 163 in each host 120 can be aggregated and provisioned as part of a virtual SAN, which is another form of shared storage 170.

A software platform 124 of each host 120 provides a virtualization layer, referred to herein as a hypervisor 150, which directly executes on hardware platform 122. In an embodiment, there is no intervening software, such as a host operating system (OS), between hypervisor 150 and hardware platform 122. Thus, hypervisor 150 is a Type-1 hypervisor (also known as a “bare-metal” hypervisor). As a result, the virtualization layer in host cluster 118 (collectively hypervisors 150) is a bare-metal virtualization layer executing directly on host hardware platforms. Hypervisor 150 abstracts processor, memory, storage, and network resources of hardware platform 122 to provide a virtual machine execution space within which multiple virtual machines (VM) 140 may be concurrently instantiated and executed. One example of hypervisor 150 that may be configured and used in embodiments described herein is a VMware ESXi™ hypervisor provided as part of the VMware vSphere® solution made commercially available by VMware, Inc. of Palo Alto, CA.

Virtualized computing system 100 is configured with a software-defined (SD) network layer 175. SD network layer 175 includes logical network services executing on virtualized infrastructure of hosts 120. The virtualized infrastructure that supports the logical network services includes hypervisor-based components, such as resource pools, distributed switches, distributed switch port groups and uplinks, etc., as well as VM-based components, such as router control VMs, load balancer VMs, edge service VMs, etc. Logical network services include logical switches and logical routers, as well as logical firewalls, logical virtual private networks (VPNs), logical load balancers, and the like, implemented on top of the virtualized infrastructure. In embodiments, virtualized computing system 100 includes edge transport nodes 178 that provide an interface of host cluster 118 to WAN 191. Edge transport nodes 178 can include a gateway (e.g., implemented by a router) between the internal logical networking of host cluster 118 and the external network. Edge transport nodes 178 can be physical servers or VMs. Virtualized computing system 100 also includes physical network devices (e.g., physical routers/switches) as part of physical network 181, which are not explicitly shown.

Virtualization management server 116 is a physical or virtual server that manages hosts 120 and the hypervisors therein. Virtualization management server 116 installs agent(s) in hypervisor 150 to add a host 120 as a managed entity. Virtualization management server 116 can logically group hosts 120 into host cluster 118 to provide cluster-level functions to hosts 120, such as VM migration between hosts 120 (e.g., for load balancing), distributed power management, dynamic VM placement according to affinity and anti-affinity rules, and high-availability. The number of hosts 120 in host cluster 118 may be one or many. Virtualization management server 116 can manage more than one host cluster 118, While only one virtualization management server 116 is shown, virtualized computing system 100 can include multiple virtualization management servers each managing one or more host clusters.

In an embodiment, virtualized computing system 100 further includes a network manager 112. Network manager 112 is a physical or virtual server that orchestrates SD network layer 175. In an embodiment, network manager 112 comprises one or more virtual servers deployed as VMs. Network manager 112 installs additional agents in hypervisor 150 to add a host 120 as a managed entity, referred to as a transport node. One example of an SD networking platform that can be configured and used in embodiments described herein as network manager 112 and SD network layer 175 is a VM ware NSX® platform made commercially available by VMware, Inc. of Palo Alto, CA. In other embodiments, SD network layer 175 is orchestrated and managed by virtualization management server 116 without the presence of network manager 112.

In embodiments, data center 101 supports multiple tenants. A tenant is an entity that can deploy and manage some resources of data center 101 for its own purposes. For example, a tenant can deploy VMs and an SDN that connects those VMs, as well as application software to execute in the VMs. Tenants can be, for example, customers, organizations, departments, business units, and the like. Data center 101 can provide tenant-isolation in that one tenant does not have access to resources deployed by another tenant (e.g., VMs, tenant networks, etc.). Thus, in embodiments, SD network layer 175 includes multiple tenant networks 176. A tenant network 176 is a logical network deployed for use by a tenant. A tenant network 176 includes various logical network components, such as a gateway, logical switches (referred to as segments), logical network services (e.g., domain name service (DNS), dynamic host control protocol (DHCP), firewall, and the like type network services), and the like. The network components of tenant network 176 are logical in that the components are implemented using software (e.g., software executing in hypervisors 150, VMs 140, edge transport nodes 178, etc.). Tenant networks 176 are deployed and managed by network manager 112.

In embodiments, software platform 124 includes tenant software 149 executing in VMs 140. Tenant software includes software deployed by multiple tenants on their respective resources (e.g., VMs 140) connected by their respective tenant networks 176. An administrator of data center 101 manages data center resources (e.g., virtualization management server 116, network manager 112, hosts 120) and all tenants. The administrator can add and remove tenants and permit tenants to utilize resources. The administrator can initially deploy a tenant network 176 for each tenant. For example, the administrator can deploy a tenant gateway for a tenant that will provide a gateway into and out of the tenant network (e.g., a logical router). The tenant gateway can be connected to an upper-level gateway managed by the administrator (e.g., the tenant gateway can be a tier-1 gateway connected to a tier-0 gateway managed by the administrator). The tenant can thereafter deploy logical network components and manage its tenant network. For example, the tenant can add segments connected to the tenant gateway, add network services (e.g., DHCP, DNS, firewalls, etc.), and the like. The tenant can interact with network manager 112 to deploy tenant network resources.

The administrator is responsible for managing tenants, including detection and resolution of tenant network problems. Data center 101 can support many tenants and hence many tenant networks 176, each having its own network topology. Hypervisors 150, VMs 140, edge transport nodes 178, etc. can generate logs that provide debugging information. However, the logging by these components may not be tenant-aware. For example, a hypervisor 150 can generate logs for logical switches without differentiating to which tenant networks those logical switches belong. In embodiments, the administrator deploys and executes tenant network topology discovery software 147. Tenant network topology discovery software 147 is configured to monitor tenant networks 176 and generate a tenant network topology model for each tenant network. The administrator can use tenant network topology models for various purposes, such as resource allocation planning based on available resources, determine root causes for network faults, identify actions that lean to particular events that can be used to reverse those operations, and the like. Operation of tenant network topology discovery software 147 is described below.

In embodiments, data center 101 communicates with a cloud 186 over WAN 191. Tenant network topology discovery software 147 can execute in cloud 186 (e.g., a software-as-a-service (SaaS) or similar cloud software). The administrator can interact with tenant network topology discovery software 147 in cloud 186 to model tenant networks 176 deployed in data center 101. In further embodiments, some portions of tenant network topology discovery software 147 can execute in data center 101, while other portions can execute in cloud 186 (or any remote data center).

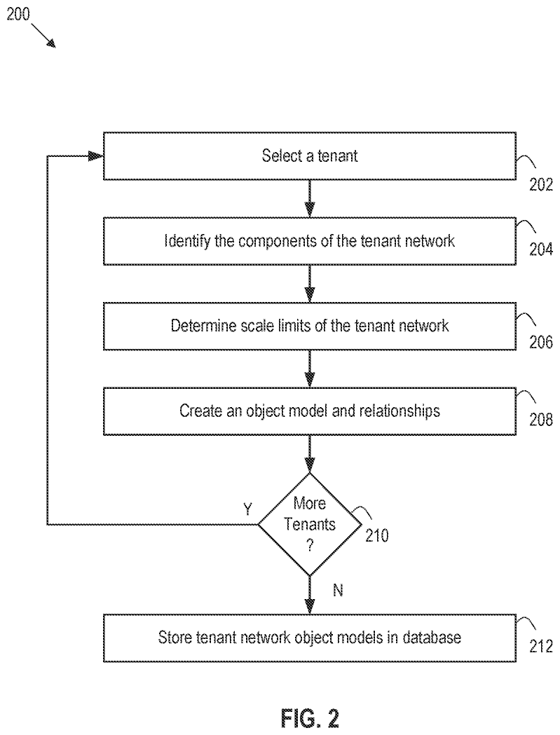

FIG. 2 is a flow diagram depicting a method 200 of generating tenant network models according to embodiments. Method 200 begins at step 202, where tenant network topology discovery software 147 selects a tenant. In embodiments, the administrator configures tenant network topology discovery software 147 with knowledge of the various tenants supported by data center 101, each having their own identifier. Alternatively, tenant network topology discovery software 147 can query control plane software of data center 101 for tenant information, such as virtualization management server 116, network manager 112, or some other control software.

At step 204, tenant network topology discovery software 147 identifies the components of the tenant network for the selected tenant. These components can include, for example, a tenant gateway, segments, network services, etc. In embodiments, tenant network topology discovery software 147 queries control plane software of data center 101 for the components, such as network manager 112. At step 206, tenant network topology discovery software 147 determines the scale limits of the tenant network. Each tenant can be allowed to deploy a certain amount of network resources (e.g., based on subscription). Tenant network topology discovery software 147 can query the control plane software (e.g., network manager 112) to identify limits on network components in the tenant network (e.g., a limit on the number of segments that can be connected to the tenant gateway).

At step 208, tenant network topology discovery software 147 generates a object model for the tenant network. The object model includes the components of the tenant network, configuration of such components, operational state of such components, and relationships between components. At step 210, tenant network topology discovery software 147 determines if there are more tenants to process. If so, method 200 returns to step 202 and selects another tenant. If not, method 200 proceeds to step 212. At step 212, tenant network topology discovery software 147 stores the network object models for the tenant networks in a database. Note that step 212 is a logical step and that tenant network topology discovery software 147 can store the network model in the database as each network model is generated.

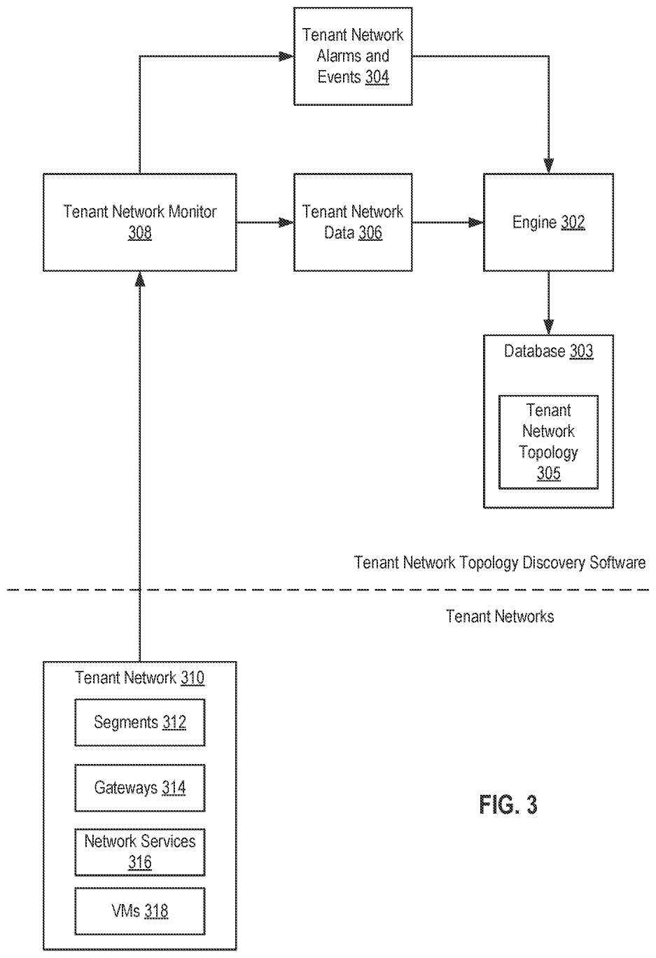

FIG. 3 is a block diagram depicting tenant network topology discovery software 147 according to embodiments. Tenant network topology discovery software 147 includes a tenant network monitor 308, an engine 302, and a database 303. Tenant network monitor 308 is configured to monitor a tenant network 310. In embodiments, tenant network monitor 308 can monitor each of the tenant networks deployed in the data center (only a single tenant network 310 is shown by way of example). In other embodiments, tenant network topology discovery software 147 can include multiple tenant network monitors 308 (e.g., one for each of the tenant networks). For purposes of clarity by example, only a single tenant network monitor 308 is shown.

Tenant network monitor 308 is configured to query control plane software in data center 101 (e.g., network manager 112) to determine the components of tenant network 310. The components of tenant network 310 can include, for example, segments 312, gateways 314, network services 316, VMs 318, or the like. VMs 318 can be those that execute network services 316 and/or gateways 314. Tenant network monitor 308 collects this information and provides tenant network data 306 to engine 302. Engine 302 generates an object model for tenant network 310, which includes an object for each network component. The object includes parameters that specify the configuration of the network component, its operational state, etc. The object can include relationships with other objects. For example, an object for a segment can include a child relationship for an object for the tenant gateway, and the object for the tenant gateway can include a parent relationship for the object for the segment. Engine 302 persists the object model and the relationships as tenant network topology 305 in database 303.

Tenant network monitor 308 is also configured to monitor tenant network 310 for alarms and events generated by tenant network 310. Alarms include information related to errors in tenant network. Events can include information related to configuration or operation of components in tenant network. For example, an alarm can be generated for a misconfiguration of a network service, when a network service goes down and is unavailable, etc. An event can be generated when the configuration of a network component changes (e.g., the IP address of a network service changes). Tenant network monitor 308 collects alarms and events and provides tenant network alarms and events 304 to engine 302. Engine 302 can then determine if such information results in an update to tenant network topology 305 (e.g., either automatically or through interaction with the administrator).

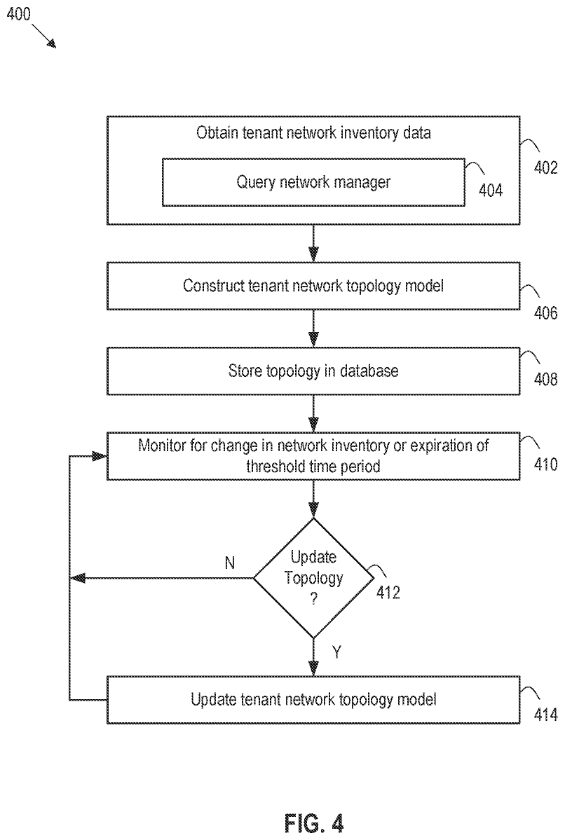

FIG. 4 is a flow diagram depicting a method 400 of managing a tenant network topology according to embodiments. Method 400 begins at step 402, where tenant network topology discovery software 147 obtains tenant network inventor data from the control plane software of data center 101 (e.g., network manager 112). For example, at step 404, tenant network topology discovery software 147 can query network manager 404 for the components, their configuration, and their operational state. At step 406, tenant network topology discovery software 147 constructs the tenant network topology model from the inventory data. At step 408, tenant network topology discovery software 147 stores the tenant network topology in the database. At step 410, tenant network topology discovery software 147 monitors the tenant network for a change in network inventory or after expiration of a time period. For example, in some embodiments, tenant network topology discovery software 147 queries the control plane for tenant network inventory data every threshold time period. In another example, tenant network topology discovery software 147 can receive notifications from the control plane (e.g., network manager 112) when the tenant modifies the tenant network (e.g., adds a new segment, adds a new service, removes an existing segment/service, etc.).

At step 412, tenant network topology discovery software 147 determines if there is an update to the topology. If not, method 400 returns to step 410 and continues monitoring. If so, method 400 proceeds to step 414, where tenant network topology discovery software 147 updates the tenant network topology model based on the changes made to the tenant network.

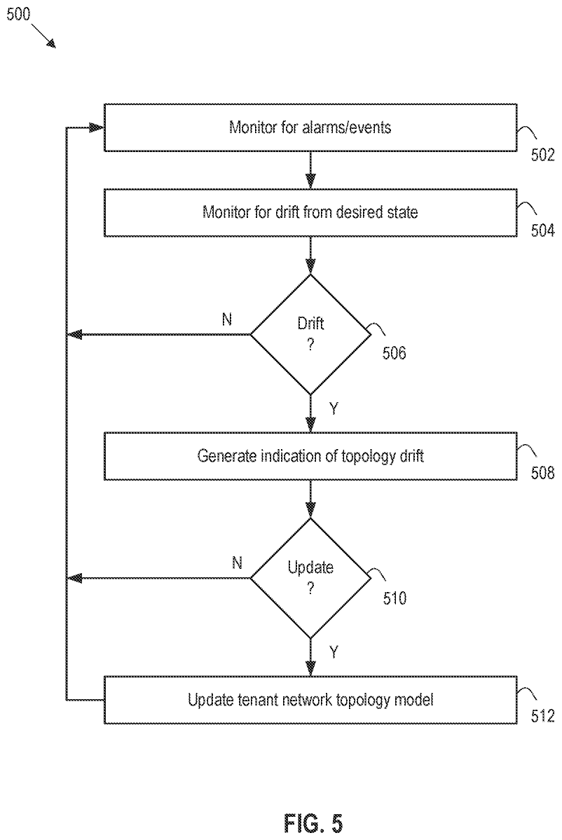

FIG. 5 is a flow diagram depicting a method 500 of managing alarms and events generated by a tenant network according to embodiments. Method 500 begins at step 502, where tenant network topology discovery software 147 monitors for alarms/events. At step 504, tenant network topology discovery software 147 monitors for drift from a desired state of the tenant network. In embodiments, tenant network topology 305 comprises a desired state of tenant network 310. Alarms/events can report information related to the operational state of tenant network components. In some cases, changes in operational state can result in changes in the tenant network topology. This represents a drift from the desired state. In some cases, the drift can be intentional and the tenant network topology should be updated accordingly. In other cases, the drift can be unintentional or undesired and the administrator can take some action to rectify the drift.

At step 506, tenant network topology discovery software 147 determines if there is a drift of the tenant network from its desired state. If not, method 500 returns to step 502 and continues monitoring. If so, method 500 proceeds to step 508. At step 508, tenant network topology discovery software 147 generates a indication of the topology drift. The topology drift can be a new component, a removed component, a change in configuration of a component, a change in operational state of a component, etc.

At step 510, tenant network topology discovery software 147 determines if there should be an update to the tenant network topology. For example, tenant network topology discovery software 147 can notify the administrator of the topology drift. The administrator can determine if the drift is permitted or unpermitted. If permitted, the topology should be updated. Otherwise, the topology should not be updated and the administrator can take action to remediate the drift. If at step 510 the topology should be updated, method 500 proceeds to step 512, where tenant network topology discovery software 147 updates the tenant network topology model to accommodate the drift. Otherwise, method 500 returns to step 502 and continues monitoring.

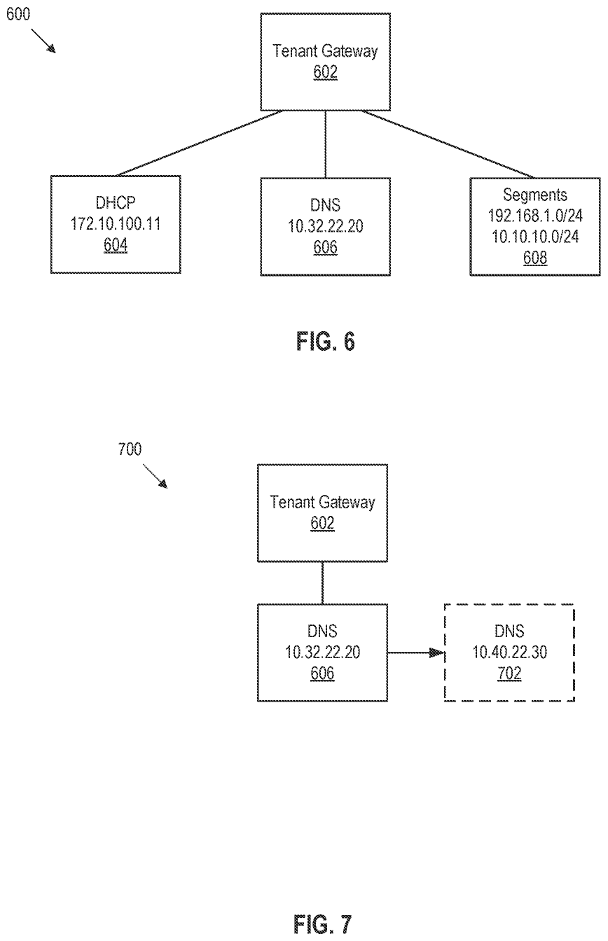

FIG. 6 is a block diagram depicting a tenant network model 600 according to embodiments. Tenant network model 600 comprises a tenant gateway 602, a DHCP service 604, a DNS service 606, and segments 608. DHCP service 604 has an IP address of 172.10.100.11. DNS service 606 has an IP address of 10.32.22.20. Segments 608 include a segment for 192.168.1.0/24 and a segment for 10.10.10.0/24. Tenant network topology discovery software 147 can generate tenant network model 600 as described in FIG. 2 above.

FIG. 7 is a block diagram depicting a tenant network model relationship 700 according to embodiments. The relationship shows tenant gateway 602 as a parent of DNS service 606. Further, due to an alarm/event, for example, tenant network includes DNS service 702. DNS service 702 has an IP of 10.40.22.30. DNS service 702 is the same network component as DNS service 606 but has a different IP address. This represents a drift from the desired state shown in FIG. 6. As shown in FIG. 5 above, tenant network topology discovery software 147 can detect this drift and notify the administrator. The administrator can determine if the drift is permitted and if so tenant network topology discovery software 147 can update the tenant network model. Otherwise, the administrator can perform some remediation (e.g., revert the IP address back to the original address).

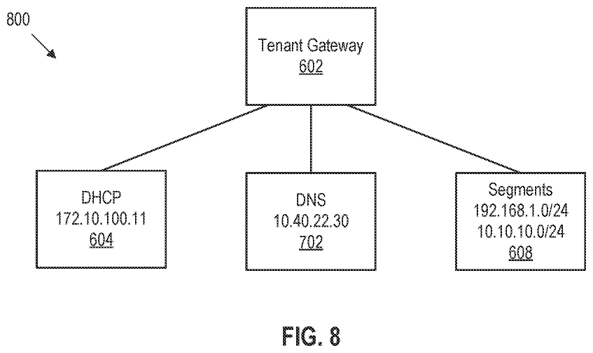

FIG. 8 is a block diagram depicting a tenant network model 800 according to embodiments. Tenant network model 800 is an update to tenant network model 600 shown in FIG. 6 to account for the drift detected with respect to DNS service 606. Tenant network model 800 includes DNS service 702 having the new IP address.

While some processes and methods having various operations have been described, one or more embodiments also relate to a device or an apparatus for performing these operations. The apparatus may be specially constructed for required purposes, or the apparatus may be a general-purpose computer selectively activated or configured by a computer program stored in the computer. Various general-purpose machines may be used with computer programs written in accordance with the teachings herein, or it may be more convenient to construct a more specialized apparatus to perform the required operations.

One or more embodiments of the present invention may be implemented as one or more computer programs or as one or more computer program modules embodied in computer readable media. The terms computer readable medium or non-transitory computer readable medium refer to any data storage device that can store data which can thereafter be input to a computer system. Computer readable media may be based on any existing or subsequently developed technology that embodies computer programs in a manner that enables a computer to read the programs. Examples of computer readable media are hard drives, NAS systems, read-only memory (ROM), RAM, compact disks (CDs), digital versatile disks (DVDs), magnetic tapes, and other optical and non-optical data storage devices. A computer readable medium can also be distributed over a network-coupled computer system so that the computer readable code is stored and executed in a distributed fashion.

Certain embodiments as described above involve a hardware abstraction layer on top of a host computer. The hardware abstraction layer allows multiple contexts to share the hardware resource. These contexts can be isolated from each other, each having at least a user application running therein. The hardware abstraction layer thus provides benefits of resource isolation and allocation among the contexts. Virtual machines may be used as an example for the contexts and hypervisors may be used as an example for the hardware abstraction layer. In general, each virtual machine includes a guest operating system in which at least one application runs. It should be noted that, unless otherwise stated, one or more of these embodiments may also apply to other examples of contexts, such as containers. Containers implement operating system-level virtualization, wherein an abstraction layer is provided on top of a kernel of an operating system on a host computer or a kernel of a guest operating system of a VM. The abstraction layer supports multiple containers each including an application and its dependencies. Each container runs as an isolated process in user-space on the underlying operating system and shares the kernel with other containers. The container relies on the kernel's functionality to make use of resource isolation (CPU, memory, block I/O, network, etc.) and separate namespaces and to completely isolate the application's view of the operating environments. By using containers, resources can be isolated, services restricted, and processes provisioned to have a private view of the operating system with their own process ID space, file system structure, and network interfaces. Multiple containers can share the same kernel, but each container can be constrained to only use a defined amount of resources such as CPU, memory and I/O.

Although one or more embodiments of the present invention have been described in some detail for clarity of understanding, certain changes may be made within the scope of the claims. Accordingly, the described embodiments are to be considered as illustrative and not restrictive, and the scope of the claims is not to be limited to details given herein but may be modified within the scope and equivalents of the claims. In the claims, elements and/or steps do not imply any particular order of operation unless explicitly stated in the claims.

Boundaries between components, operations, and data stores are somewhat arbitrary, and particular operations are illustrated in the context of specific configurations. Other allocations of functionality are envisioned and may fall within the scope of the appended claims. In general, structures and functionalities presented as separate components in exemplary configurations may be implemented as a combined structure or component. Similarly, structures and functionalities presented as a single component may be implemented as separate components. These and other variations, additions, and improvements may fall within the scope of the appended claims.

What is claimed is:

1. A method of managing tenant networks in a data center, comprising:
obtaining, by tenant network topology discovery software executing in the data center, inventory data for a tenant network deployed in the data center from a network manager, the tenant network comprising a software-defined network managed by the network manager;
generating, by the tenant network topology discovery software, a tenant network model based on the inventory data, the tenant network model including objects representing components of the tenant network and relationships between the components;
storing, by the tenant network topology discovery software, the tenant network model in a database; and
updating, by the tenant network topology discovery software, the tenant network model in response to monitoring the tenant network.

2. The method of claim 1, wherein the step of updating comprises:
obtaining, after expiration of a time period, additional inventory data for the tenant network by the tenant network topology discovery software; and
updating the tenant network model in response to the additional inventory data.

3. The method of claim 1, wherein the step of updating comprises:
receiving, at the tenant network topology discovery software, additional inventory data for the tenant network in response to a change made by a tenant; and
updating the tenant network model in response to the additional inventory data.

4. The method of claim 1, wherein the step of updating comprises:
receiving, at the tenant network topology discovery software, an alarm or an event from the tenant network;
determining, by the tenant network topology discovery software, a drift from a desired state of the tenant network model based on the alarm or the event;
generating an indication of the drift by the tenant network topology discovery software;
updating the tenant network model in response to the drift.

5. The method of claim 1, further comprising:
receiving, at the tenant network topology discovery software, an alarm or an event from the tenant network;
determining, by the tenant network topology discovery software, a drift from a desired state of the tenant network model based on the alarm or the event;
generating an indication of the drift by the tenant network topology discovery software;
remediating the drift without updating the tenant network topology.

6. The method of claim 1, wherein the data center comprises a plurality of hosts and hypervisors executing on the hosts, the hypervisors implementing a software-defined network layer, the tenant network implemented in the software-defined network layer.

7. The method of claim 1, wherein the tenant network comprises a tenant gateway, at least one segment, and at least one network service.

8. A non-transitory computer readable medium comprising instructions to be executed in a computing device to cause the computing device to carry out a method of managing tenant networks in a data center, comprising:
obtaining, by tenant network topology discovery software executing in the data center, inventory data for a tenant network deployed in the data center from a network manager, the tenant network comprising a software-defined network managed by the network manager;
generating, by the tenant network topology discovery software, a tenant network model based on the inventory data, the tenant network model including objects representing components of the tenant network and relationships between the components;
storing, by the tenant network topology discovery software, the tenant network model in a database; and
updating, by the tenant network topology discovery software, the tenant network model in response to monitoring the tenant network.

9. The non-transitory computer readable medium of claim 8, wherein the step of updating comprises:
obtaining, after expiration of a time period, additional inventory data for the tenant network by the tenant network topology discovery software; and
updating the tenant network model in response to the additional inventory data.

10. The non-transitory computer readable medium of claim 8, wherein the step of updating comprises:
receiving, at the tenant network topology discovery software, additional inventory data for the tenant network in response to a change made by a tenant; and
updating the tenant network model in response to the additional inventory data.

11. The non-transitory computer readable medium of claim 8, wherein the step of updating comprises:
receiving, at the tenant network topology discovery software, an alarm or an event from the tenant network;
determining, by the tenant network topology discovery software, a drift from a desired state of the tenant network model based on the alarm or the event;
generating an indication of the drift by the tenant network topology discovery software;
updating the tenant network model in response to the drift.

12. The non-transitory computer readable medium of claim 8, further comprising:
receiving, at the tenant network topology discovery software, an alarm or an event from the tenant network;
determining, by the tenant network topology discovery software, a drift from a desired state of the tenant network model based on the alarm or the event;
generating an indication of the drift by the tenant network topology discovery software;
remediating the drift without updating the tenant network topology.

13. The non-transitory computer readable medium of claim 8, wherein the data center comprises a plurality of hosts and hypervisors executing on the hosts, the hypervisors implementing a software-defined network layer, the tenant network implemented in the software-defined network layer.

14. The non-transitory computer readable medium of claim 8, wherein the tenant network comprises a tenant gateway, at least one segment, and at least one network service.

15. A computer system, comprising:
a plurality of hosts having hypervisors executing thereon;
a network manager configured to managing a software-defined network layer implemented in the hypervisors;
tenant network topology discovery software executing on the plurality of hosts configured to:
obtain inventory data for a tenant network deployed in the data center from a network manager, the tenant network comprising a software-defined network managed by the network manager;
generate a tenant network model based on the inventory data, the tenant network model including objects representing components of the tenant network and relationships between the components;
store the tenant network model in a database; and
updating the tenant network model in response to monitoring the tenant network.

16. The computer system of claim 15, wherein the tenant network topology discovery software performs the updating by:
obtaining, after expiration of a time period, additional inventory data for the tenant network by the tenant network topology discovery software; and
updating the tenant network model in response to the additional inventory data.

17. The computer system of claim 15, wherein the tenant network topology discovery software performs the updating by:
receiving, at the tenant network topology discovery software, additional inventory data for the tenant network in response to a change made by a tenant; and
updating the tenant network model in response to the additional inventory data.

18. The computer system of claim 15, wherein the tenant network topology discovery software performs the updating by:
receiving, at the tenant network topology discovery software, an alarm or an event from the tenant network;
determining, by the tenant network topology discovery software, a drift from a desired state of the tenant network model based on the alarm or the event;
generating an indication of the drift by the tenant network topology discovery software;
updating the tenant network model in response to the drift.

19. The computer system of claim 15, wherein the tenant network topology discovery software is configured to:
receive an alarm or an event from the tenant network;
determine a drift from a desired state of the tenant network model based on the alarm or the event;
generate an indication of the drift; and
remediate the drift without updating the tenant network topology.

20. The computer system of claim 15, wherein the data center comprises a plurality of hosts and hypervisors executing on the hosts, the hypervisors implementing a software-defined network layer, the tenant network implemented in the software-defined network layer.
